(19) United States
(12) Patent Application Publication
(10) Pub. No.: US 2021/0129727 A1
(43) Pub. Date: May 6, 2021

(54) OUTER HINGE PRESS FIT INTERFACE FOR BACKREST WITH TRUNK RELEASE

(71) Applicant: LEAR CORPORATION, Southfield, MI (US)

(72) Inventors: Gregory PISTILLI, Freising (DE); Florian GERBL, Berglern (DE); Alexej NIEDERHAUS, Velden (DE); Mathias BUSCH, Freising (DE); Tino SCHNEIDER, Isen (DE); Rajdeep RAJPUT, Freising (DE); Michael SCHUHBAUER, Schweitenkirchen (DE); Arunkumar BODA, Ingolstadt (DE)

(73) Assignee: LEAR CORPORATION, Southfield, MI (US)

(21) Appl. No.: 17/070,575

(22) Filed: Oct. 14, 2020

(30) Foreign Application Priority Data
Nov. 4, 2019 (DE) 10 2019 216 975.9

(51) Int. Cl. B60N 2/90; B60N 2/68

(52) U.S. Cl. CPC B60N 2/933; B60N 2002/952; B60N 2002/684; B60N 2/682

(57) ABSTRACT

A hinge assembly for integration into a seat release system includes a pivot stud having a shaft section and a first head section and an outer hinge component attached to the first head section of the pivot stud. The shaft section is adapted to be connected to a spring element of the pivot stud. The first head section has a rounded star-shaped cross-section with three or more protrusions converging in a direction outward from a center of the rounded star-shaped cross-section with at least one flat-ended protrusion. The outer hinge component defines a top wall and a sidewall. The top wall is adapted to be attached to a vehicle body structural component. Characteristically, the sidewall defines an opening into which the first head section of the pivot stud is positioned. A vehicle seat release system incorporating the hinge assembly is also provided.

### CROSS-REFERENCE TO RELATED APPLICATIONS

This application claims foreign priority benefits under 35 U.S.C. § 119(a)-(d) to De application 10 2019 216 975.9, filed Nov. 4, 2019, the disclosure of which is hereby incorporated by reference in its entirety.

### TECHNICAL FIELD

In at least one aspect, an improved trunk release system with reduce hinge wear is provided.

### BACKGROUND

Modern automobiles can include a number of mechanical mechanisms that provide user actuated operations such as trunk release, gas cover release, and vehicle seat adjustment. FIGS. 1A, 1B, and 1C illustrate a prior art vehicle seat release system. Vehicle seat 10 includes vehicle seat pivoting assembly 12 which is integrated into seatback 14. Vehicle seat pivoting system 12 is attached to seatback structural component 16 via brackets 18 and 19. Seat release assembly 12 includes hinge 20 that attaches to vehicle body structural component 22. Seat release assembly 12 also includes a pivot stud 24 which is coupled to a spring element 26. Hinge 20 is attached to pivot stud 24 via opening 30 which is typically rectangular or trapezoidal shaped. User actuation of release latch 32a or 32b initiates release of structural component 22 causing seatback 14 to rotate about axis a₁ and spring element 26 to twist. Although this design work reasonably well, opening 30 is subject to wear due to a spring force concentrated on load zones 34. Wear at these locations leads to unacceptable free play and rattling noise.

Accordingly, there is a need for improved vehicle release mechanisms that avoid undesirable free play and loss of function.

### SUMMARY

The present invention solves one or more problems of the prior art by providing in at least one aspect a hinge assembly for integration into a vehicle seat pivoting system. The hinge assembly includes a pivot stud that includes a shaft section disposed between a first end and a second end. The pivot stud also includes a first head section at the first end. The shaft section is adapted to be connected to a spring element. Characteristically, the first head section has a rounded star-shaped cross-section with three or more protrusions converging in a direction outward from a center of the rounded star-shaped cross-section and at least one flat-ended protrusion. A hinge component is attached to the first head section of the pivot stud. The hinge component defines a top wall and a sidewall. The sidewall defines an attachment opening into which the first head section of the pivot stud is positioned. The hinge component is fixed to the body of the vehicle at a vehicle body structural component at the top wall of the hinge component. Advantageously, the attachment opening has a shape that matches the first head section. Typically, the vehicle seat pivoting assembly is integrated into a vehicle seat. In this regard, the vehicle seat pivoting system is attached to a vehicle seat structural component and in particular, a vehicle seatback frame. When the vehicle seat structural component is locked by a release latch, the spring element is deformed and loads are distributed between the vehicle seat structural component (e.g., vehicle seatback frame) and the hinge. When the vehicle seat structural component is released via user activation of the release latch, the spring force from the spring element causes the vehicle seat structural component to pivot around the shaft section. Advantageously, the rounded star-shape of the first head section results in reduced wear on the attachment opening.

In another aspect, a vehicle seat incorporating the hinge assembly set forth herein is provided. The vehicle seat includes a seat bottom, a seatback including a seatback frame and one or more components of a vehicle seat release system including a spring element, and a hinge assembly attached to the spring element. The hinge assembly includes a pivot stud that includes a shaft section disposed between a first end and a second end. The pivot stud also includes a first head section at the first end. The shaft section is adapted to be connected to a spring element. Characteristically, the first head section has a rounded star-shaped cross-section with three or more protrusions converging in a direction outward from a center of the rounded star-shaped cross-section and at least one flat-ended protrusion. A hinge component is attached to the first head section of the pivot stud. The hinge component defines a top wall and a sidewall. The sidewall defines an attachment opening into which the first head section of the pivot stud is positioned. The top wall of the hinge component is fixed to the body of the vehicle at a vehicle body structural component. The attachment opening has a shape that matches the first head section. The vehicle seat pivoting assembly is integrated into the vehicle seatback. In this regard, the vehicle seat pivoting system is attached to the vehicle seatback frame. When the vehicle seatback frame is locked by a release latch, the spring element is deformed, and loads are distributed between the vehicle seat structural component and the hinge. When the vehicle seatback frame is released via user activation of the release latch, the spring force from the spring element causes the seatback frame to pivot around the shaft section. Advantageously, due to the shape of the head section, the pivot stud cannot rotate in the hinge thereby ensuring that the spring will be twisted between the structure and the stud.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1A is a schematic illustration of a prior art vehicle seat release system that is subject to wear at the coupling between the hinge and a pivot stud.

FIG. 1B is a schematic illustration of a hinge showing points subject to wear.

FIG. 1C is a schematic illustration of a hinge showing the effect of wear result in loss of function and rattling noise.

FIG. 2 is a cross-sectional view of the hinge assembly.

FIG. 3 is a perspective view of a hinge component of the hinge assembly.

FIG. 4A is a perspective view of the pivot stud incorporated into the hinge assembly of FIGS. 2 and 3.

FIG. 4B is a side view of the pivot stud.

FIG. 4C is a cross-sectional view of the head section of the pivot stud.

FIG. 5 is a sideview illustrating the positions of load zones that distribute the load more efficiently that the hinge designs of the prior art

FIG. 6 is a schematic showing the integration of the hinge assembly of FIGS. 2 and 3 into a vehicle seat.

### DETAILED DESCRIPTION

Reference will now be made in detail to compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Throughout this application, where publications are referenced, the disclosures of these publications in their entireties are hereby incorporated by reference into this application to more fully describe the state of the art to which this invention pertains.

The following examples illustrate the various embodiments of the present invention. Those skilled in the art will recognize many variations that are within the spirit of the present invention and scope of the claims.

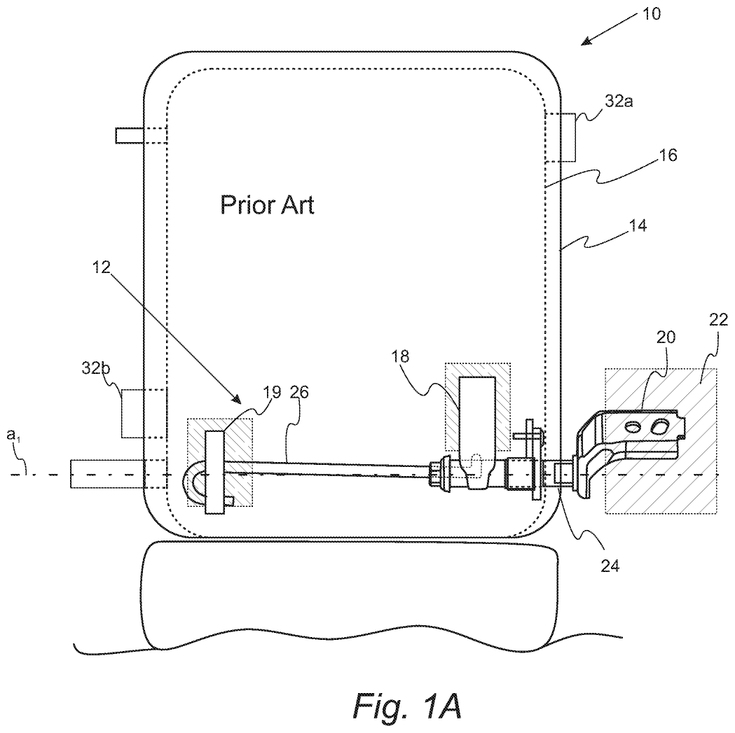

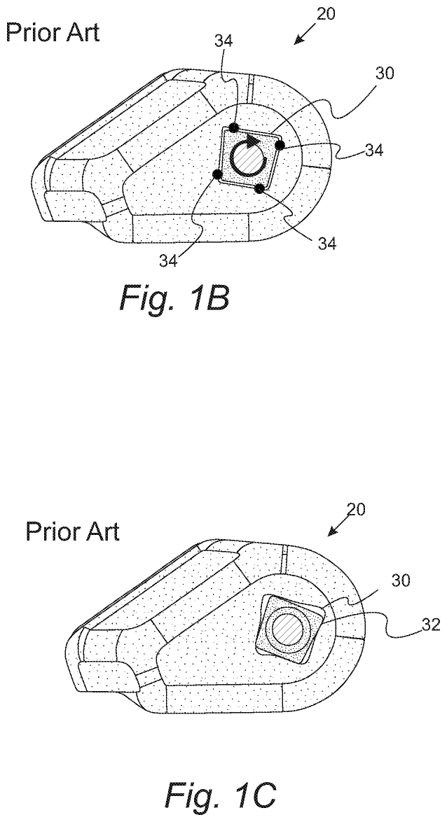

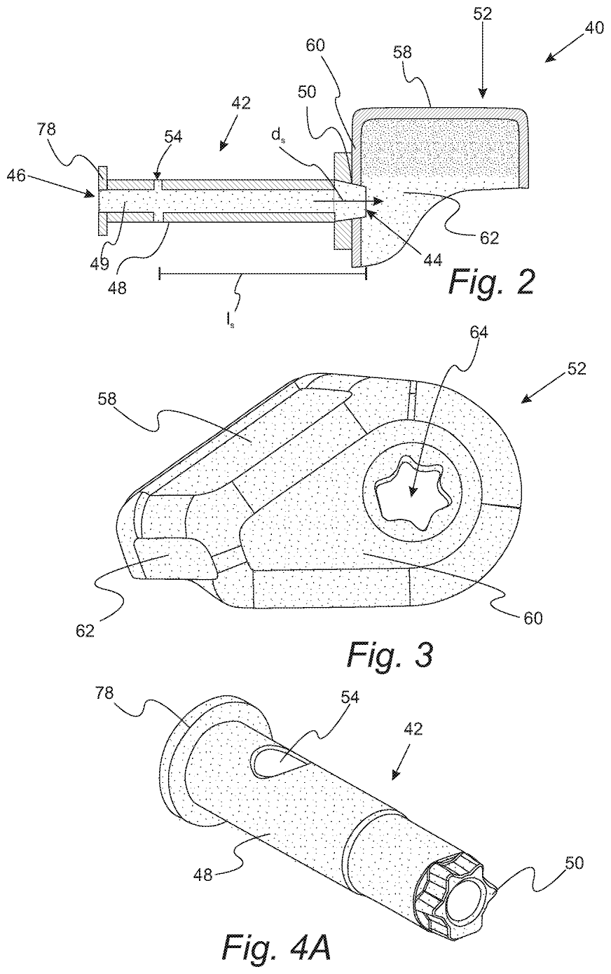

With reference to FIGS. 2 and 3, schematic illustrations of a hinge assembly for integration into a vehicle seat release system is provided. FIG. 2 is a cross-sectional view of the hinge assembly. FIG. 3 is a perspective view of a hinge component of the hinge assembly. Hinge assembly 40 of the present embodiment can replace the prior art hinge of FIGS. 1A, 1B, and 1C. Hinge assembly 40 includes pivot stud 42 having a first end 44 and a second end 46. Pivot stud 42 includes shaft section 48 and first head section 50. Hinge assembly 40 also includes outer hinge component 52 attached to first head section 50 of the pivot stud. Shaft section 48 is adapted to be connected to a spring element as set forth below in more detail. In this regard, pivot stud 42 defines an attachment hole 54 which extends at least partially through shaft section 48. In a refinement, the shaft section defined a hollow core 49 thereby allowing a portion of the spring element. Attachment hole 54 is separated from the end of first head section 50 by distance is which is several centimeters (e.g., 5 to 80 cm). Hinge component 52 includes top wall 58, sidewall 60, and sidewall 62. Hinge component 52 is adapted to be attached to a vehicle body structural component (e.g., floor). Sidewall 60 defines attachment opening 64 that has a shape mating to first head section 50 when first head section 50 is positioned therein. FIG. 2 depicts pivot stud 42 attached to hinge component 52. In a refinement, first head section tapers in a direct dₛ towards the end of the first head section. This tapering allows pivot stud 42 to be attached to hinge component 52 with a press fit. In a refinement, pivot stud 42 and hinge component 52 are formed from a metal (e.g., steel).

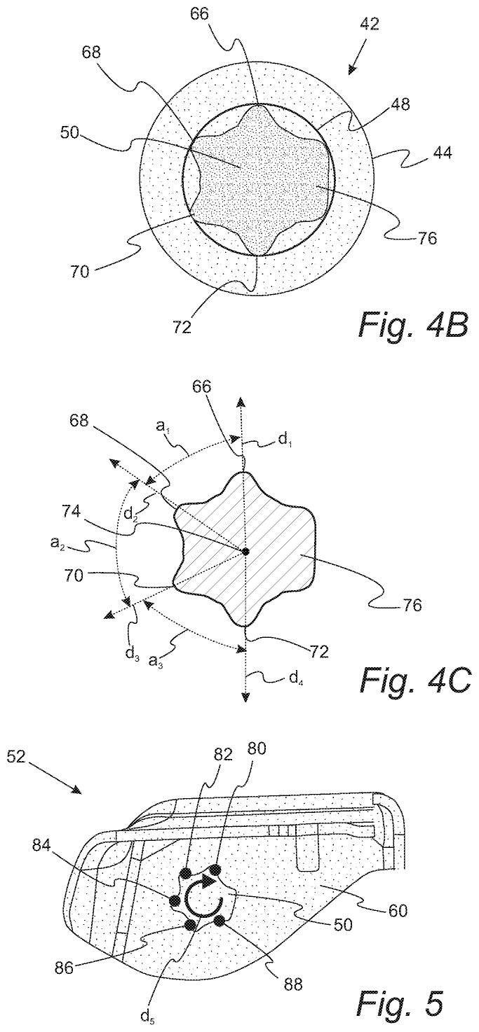

With reference to FIGS. 4A, 4B, and 4C, schematics of pivot stud 32 are provided. FIG. 4A is a perspective view of the pivot stud. FIG. 4B is a side view of the pivot stud. FIG. 4C is a cross-sectional view of the head section of the pivot stud. In a variation, first head section 50 has a rounded star-shaped cross-section with three or more protrusions 66, 68, 70, 72 narrowing towards an apex in directions d₁, d₂, d₃, d₄ outward from a center 74 of the rounded star-shaped cross-section. In a refinement, first head section 50 includes 5 or more protrusions narrowing towards an apex in directions d₁, d₂, d₃, d₄, d₆ outward from a center 74 of the rounded star-shaped cross-section. In the example depicted in FIGS. 4A, 4B, and 4C, 4 of these narrowing protrusions are provided. The apex for each protrusion 66, 68, 70, 72 is the point of maximum distance on the protrusion from center 74. Directions d₁, d₂, d₃, d₄ emanate from center 74. In a refinement, directions d₁, d₂, d₃, d₄ are separated by an angle from about 45 degrees to about 120 degrees. Rounded star-shaped cross-section also includes at least one flat-ended protrusion 66. Pivot stud 32 includes second head section 78 which on the opposite end to first head section 50 which assists in mounting the hinge assembly to a vehicle seat. In a refinement, second head section 78 is disc-shaped with a radius that is larger than the radius of shaft section 48. Hollow core 49 extends through second head section 78.

The design of first head section 50 is analogous to a TORX® screw design which is known to distribute load forces during rotation. FIG. 5 illustrates the positions of load zones 80, 82, 84, 86, 88 which distribute the load more efficiently than the hinge designs of the prior art. As depicted head section 50 is attached to sidewall 60 with a press fit. A torque about direction d₅ results in a distribution of the load at load zones 80, 82, 84, 86, 88.

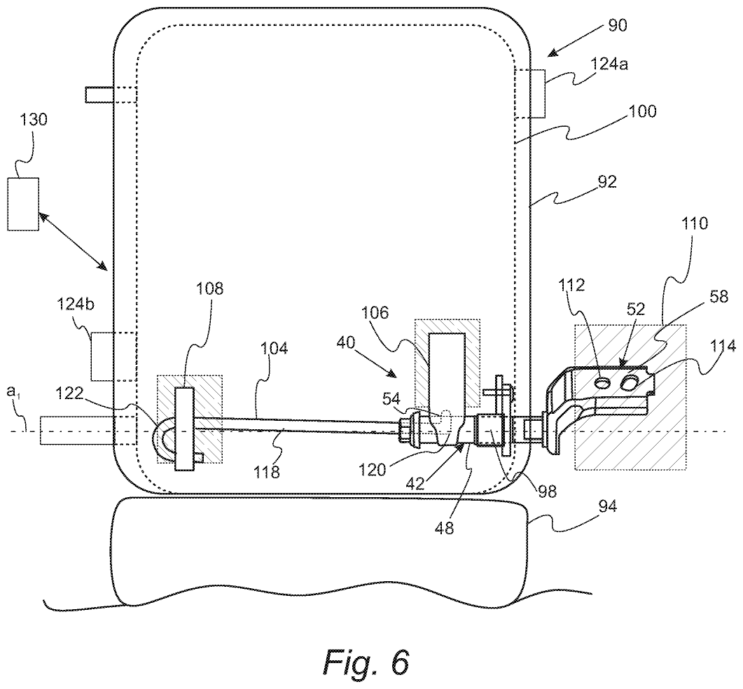

With reference to FIG. 6, a schematic illustrating the incorporation of the hinge assembly set forth above into a vehicle seat is provided. Vehicle seat 90 includes seatback 92 having a seatback frame and seat bottom 94. In a refinement, hinge assembly 40 is attached to seatback 92. At least one bracket 106 is used to hold pivot stud 42 to seatback frame 100 while allowing rotation of the pivot stud. Bracket 108 attaches spring element 104 to seatback frame 100. Hinge component is attached to vehicle body at vehicle body structural component 110. Holes 112 and 114 defined by top wall 58 can be used to bolt the hinge component to vehicle body structural component 110. Pivot stud 42 is attached to spring element 104. In a refinement, spring element 104 includes spring shaft section 118 disposed between first bent end section 120 and a second bent end section 122. First bent end section 120 is attached to the attachment hole 54 (see FIGS. 2 and 3) in the pivot stud. User actuation of release latch 124a and/or 124b initiates release of structural component 100 causing seatback 92 rotate about axis a₁ and spring element 104. Release latch 124a is attached near the top of vehicle seat structural component 100 while release latch 124b is attached near the bottom of vehicle seat structural component 100. When the vehicle seat structural component 100 is locked by release latch 124a or 124b, the spring element 104 is deformed and loads are distributed between the vehicle seat structural component and the hinge component 52 with the wear being reduced as depicted in FIG. 5. When the vehicle seat structural component is released via user activation of release latch 124a or 124b, the spring force from the spring element 104 causes the vehicle seat structural component 100 to pivot around the shaft section 48 (i.e., axis a₁.) In a refinement, trunk latch 130 can also be placed within a vehicle trunk. Trunk latch 130 releases the seatback frame in the same manner as release latches 124a and 124b.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A hinge assembly for integration into a seat release system, the hinge assembly comprising:
a pivot stud including a shaft section disposed between a first end and a second end, the pivot stud also including a first head section at the first end, the shaft section adapted to be connected to a spring element, the first head section having a rounded star-shaped cross-section with three or more protrusions converging in a direction outward from a center of the rounded star-shaped cross-section and at least one flat-ended protrusion; and
a hinge component attached to the first head section of the pivot stud, the hinge component defining a top wall and a sidewall, the sidewall defining an attachment opening into which the first head section of the pivot stud is positioned, the attachment opening having a shape that matches the first head section.

2. The hinge assembly of claim 1, wherein the first head section tapers towards the first end.

3. The hinge assembly of claim 2, wherein the first head section is attached to the attachment opening by a press fit.

4. The hinge assembly of claim 1, wherein the pivot stud defines an attachment hole through the shaft section that is connectable to the spring element.

5. The hinge assembly of claim 1, wherein the first head section defines at least 5 protrusions.

6. The hinge assembly of claim 1, wherein the first head section defines 5 protrusions.

7. The hinge assembly of claim 1, wherein the pivot stud and the hinge component each independently formed from metal.

8. The hinge assembly of claim 1, wherein the pivot stud defines a hollow core that allows a portion of the spring element to pass therethrough.

9. The hinge assembly of claim 8, wherein a second head section is positioned at the second end of the pivot stud.

10. The hinge assembly of claim 9, wherein the second head section is disc-shaped with the hollow core passing therethrough.

11. A vehicle seat comprising:
a seat bottom;
a seatback including a seatback frame, a release latch, and one or more components of a vehicle seat release system including a spring element; and
a hinge assembly attached to the spring element, the hinge assembly comprising:
a pivot stud including a shaft section disposed between a first end and a second end, the pivot stud also including a first head section at the first end, the shaft section adapted to be connected to the spring element, the first head section having a rounded star-shaped cross-section with three or more protrusions converging in a direction outward from a center of the rounded star-shaped cross-section and at least one flat-ended protrusion; and
a hinge component attached to the first head section of the pivot stud, the hinge component defining a top wall and a sidewall, the sidewall defining an attachment opening into which the first head section of the pivot stud is positioned, the attachment opening having a shape that matches the first head section, the hinge component is attachable to a vehicle body at a vehicle body structural component, wherein when the seatback frame is locked by the release latch, the spring element is deformed and loads are distributed between the seatback frame and the hinge component and when the seatback frame is released via user activation of the release latch, a spring force from the spring element causes the seatback frame to pivot around the shaft section.

12. The vehicle seat of claim 11, wherein the first head section tapers towards the first end.

13. The vehicle seat of claim 12, wherein the first head section is attached to the attachment opening by a press fit.

14. The vehicle seat of claim 11, wherein the pivot stud defines an attachment hole through the shaft section that is connectable to the spring element.

15. The vehicle seat of claim 14, wherein the spring element includes a shaft disposed between a first bent end section and a second bent end section.

16. The vehicle seat of claim 15, wherein the first bent end section attaches to the attachment hole in the pivot stud.

17. The vehicle seat of claim 11, wherein the first head section defines at least 5 protrusions.

18. The vehicle seat of claim 11, wherein the first head section defines 5 protrusions.

19. The vehicle seat of claim 11, wherein the pivot stud and the hinge component each independently formed from metal.

20. The vehicle seat of claim 11, further comprising a trunk latch that is operable to release the seatback frame.
